(19) United States
(12) Patent Application Publication
(10) Pub. No.: US 2019/0364614 A1
(43) Pub. Date: Nov. 28, 2019

(54) WIRELESS COMMUNICATION DEVICE

(71) Applicant: NORITZ CORPORATION, HYOGO (JP)

(72) Inventors: Yoshihiko MAEKAWA, Hyogo (JP); Masayuki SUGIOKA, Hyogo (JP); Tsuyoshi YAMASHITA, Hyogo (JP); Daisuke HIROTA, Hyogo (JP); Yasunori IMI, Hyogo (JP); Masahiro NISHIKAWA, Hyogo (JP); Naoki TAWADA, Hyogo (JP); Masaru ONO, Hyogo (JP)

(73) Assignee: NORITZ CORPORATION, HYOGO (IT)

(21) Appl. No.: 16/486,154

(22) PCT Filed: Feb. 23, 2018
(86) PCT No.: PCT/JP2018/006749

§ 371 Date: Aug. 15, 2019

(30) Foreign Application Priority Data
Mar. 1, 2017 (JP) 2017-037929

(51) Int. Cl. H04W 88/02; H04B 1/16; H04B 1/38

(52) U.S. Cl. CPC H04W 88/02; H04W 84/12; H04B 1/38; H04B 1/16

(57) ABSTRACT

In a small-scale LAN relay adaptor for collecting various information from a hot-water supply system and transmitting the information to a management server via a wireless LAN router, three LEDs arranged in a single row and a control part for performing light emission control of the LEDs are included, wherein the control part is configured to be capable of switching an operation mode to a state display mode or a reception intensity display mode. During the state display mode, the control part issues a notification of the occurrence of three error states respectively using the three LEDs. On the other hand, during the reception intensity display mode, the control part performs reception intensity display processing for displaying the magnitude of reception intensity from the wireless LAN router using the three LEDs as a level meter.

### BACKGROUND OF THE INVENTION

### Technical Field

The present invention relates to a wireless communication device that performs wireless communication with other wireless communication devices such as a wireless LAN router and the like, in particular, to a wireless communication device that is one wireless communication device constituting a small-scale local area network and disposed fixedly at a specific location.

### Related Art

As for a network machine using wireless communication, communication connection easily becomes unstable due to external factors. The factors causing unstable communication connection are various and fundamental is confirmation of radio wave intensity.

In the network machine such as an energy monitor that has a liquid-crystal display panel, generally, the radio wave intensity of a reception radio wave from a communication target such as an access point and the like can be visually confirmed by an antenna display (antenna picture) which is also widely used in mobile phones, smart phones or the like.

On the other hand, in a small-scale local area network machine such as a wireless LAN adapter that is connected with a wireless router within premises and in a relatively close distance, and that only has LEDs as a display device, as also disclosed in the following patent literature 1 for example, the radio wave intensity may be displayed by varying light-emitting colors of the LEDs.

### LITERATURE OF RELATED ART

### Patent Literature

Patent literature: Japanese Laid-Open No. 2016-10131

### SUMMARY

### Problems to be Solved

However, in displaying the radio wave intensity by light-emitting colors, there is a problem that the correspondence between the color and the degree of the radio wave intensity can only be understood with reference to a manual or the like. Therefore, in order to intuitively display the radio wave intensity to make it understood easily, preferably, a plurality of LEDs for radio wave intensity display is arranged and the plurality of LEDs are used as a level meter to display the radio wave intensity.

On the other hand, the applicant of the present application is developing a remote management system for hot-water supply system, which remotely monitors various information of a hot-water supply system disposed in the premises of a user by a management server disposed in a remote location. A common hot-water supply system includes a two-core communication circuit as a communication part, and is configured to be capable of performing serial communication between system configuration equipment such as a hot-water supply device, a remote controller and the like via a two-core communication line. Because a TCP/IP communication circuit for communication connection with a wireless router is not arranged on the hot-water supply device and the remote controller, it is required that a relay adaptor which communicates with the hot-water supply system via the two-core communication line is disposed inside the premises of the user and a wireless LAN module is built in the relay adaptor, thereby communicably connecting the relay adaptor with the management server via the wireless router.

In the aforementioned relay adaptor for hot-water supply system, in order to confirm the connection during construction and specify failure occurrence position when various failure occurs, preferably, three communication establishment confirmation LEDs, which are used to respectively display whether communication between the relay adaptor with the hot-water supply system, the wireless LAN router and the management server are established respectively, are arranged on the relay adaptor.

However, in order to arrange the aforementioned plurality of radio wave intensity display LEDs and the three communication establishment confirmation LEDs, installing areas for the multiple LEDs are required, and driving circuits of the multiple LEDs are also required, leading to upsizing or cost increase of the relay adaptor as well as an increase in power consumption.

On the other hand, because the relay adaptor does not experience great change in wireless communication environment due to movement as a portable wireless terminal does, if the radio wave reception intensity can be confirmed during a setting operation, maintenance or the like, there is no need to constantly display the radio wave intensity. In addition, as for the small-scale local area network machine, there is a large requirement on cost reduction, low power consumption or size reduction, and the number of LEDs is desired to be reduced as much as possible.

Therefore, the present invention provides a wireless communication device which is capable of issuing a notification concerning a radio wave reception intensity and the occurrence of various states such as an error state using an inexpensive display device such as LEDs, while achieving a decrease in the number of components.

### Means to Solve Problems

The present invention takes the following technical means to achieve the aforementioned purpose.

That is, the present invention is a wireless communication device which performs wireless communication with other wireless communication devices and includes a control part and a first light-emitting element, a second light-emitting element and a third light-emitting element to which light emission control can be independently performed by the control part. The first light-emitting element to the third light-emitting element are arranged in a single row. The control part is configured to be capable of switching an operation mode to a state display mode or a reception intensity display mode. During the state display mode, the control part implements first notification processing in which a first light-emitting element is used to notify when a predetermined first state occurs, the occurrence of the first state, second notification processing in which a second light-emitting element is used to notify, when a predetermined second state occurs, the occurrence of the second state, and third notification processing in which a third light-emitting element is used to notify, when a predetermined third state occurs, the occurrence of the third state. During the reception intensity display mode, the control part implements reception intensity display processing for displaying the magnitude of reception intensity from other wireless communication devices using the first light-emitting element to the third light-emitting element as a level meter.

According to the wireless communication device of the present invention, when the control part is switched to the state display mode, whether the first state to the third state occur or not can be simultaneously notified by the first light-emitting element to the third light-emitting element. Therefore, for example, when the present invention is applied to the relay adaptor serving as a wireless communication device that collects information of a hot-water supply system and transmits the information of the hot-water supply system to a management server via a wireless router, communication error occurrence positions can be easily specified by configuring the control part in a manner that the first light-emitting element is lighted or made to blink when a communication error with the hot-water supply system occurs, the second light-emitting element is lighted or made to blink when a communication error with the wireless router occurs, and the third light-emitting element is lighted or made to blink when a communication error with the management server occurs. On the other hand, when the control part is switched to the reception intensity display mode, by using the first light-emitting element to the third light-emitting element as a level meter to display the magnitude of the reception intensity from other wireless communication devices, the reception intensity can be displayed to be easy to understand visually by the plurality of light-emitting elements arranged in a single row without adding light-emitting elements for reception intensity display.

In addition, the present invention may be a wireless communication device which performs wireless communication with other wireless communication devices and includes a control part and a first light-emitting element and a second light-emitting element to which light emission control can be independently performed by the control part. The control part is configured to be capable of switching an operation mode to a state display mode or a reception intensity display mode. During the state display mode, the control part implements first notification processing in which the first light-emitting element is used to notify, when a predetermined first state occurs, the occurrence of the first state, and second notification processing in which the second light-emitting element is used to notify, when a predetermined second state occurs, the occurrence of the second state. During the reception intensity display mode, the control part implements reception intensity display processing for displaying the magnitude of reception intensity from other wireless communication devices using the first light-emitting element and the second light-emitting element as a level meter.

According to the wireless communication device of the present invention, when the control part is switched to the state display mode, whether the first state and the second state occur or not can be notified by the first light-emitting element and the second light-emitting element. Therefore, for example, when the present invention is applied to a relay adaptor serving as a wireless communication device that collects information of a hot-water supply system and transmits the information of the hot-water supply system to a management server, communication error occurrence positions can be easily specified by configuring the control part in a manner that the first light-emitting element is lighted or made to blink when a communication error with the hot-water supply system occurs and the second light-emitting element is lighted or made to blink when a communication error with other wireless communication devices such as a wireless router occurs. On the other hand, when the control part is switched to the reception intensity display mode, by using the first light-emitting element and the second light-emitting element as a level meter to display the magnitude of the reception intensity from other wireless communication devices, the reception intensity can be displayed to be easy to understand visually by the number of the light-emitting elements being lighted without adding light-emitting elements for reception intensity display.

In the wireless communication device of the present invention, an operation part for switching the operation mode of the control part from the state display mode to the reception intensity display mode may be further included, and the control part may be configured to be automatically switched to the state display mode when a predetermined time elapses after the control part is switched to the reception intensity display mode by the operation of the operation part. Accordingly, during a normal state, by operating the control part in the state display mode, the occurrence of various state can be respectively notified using the plurality of light-emitting elements. On the other hand, when confirmation of the reception intensity is required, by temporarily switching the operation mode to the reception intensity display mode by operating the operation part, the plurality of light-emitting elements can be used as a level meter to display the reception intensity. Furthermore, because it is automatically switched to the state display mode when a predetermined time elapses, a state is set to the reception intensity display mode does not remain.

In addition, a power lamp disposed apart from the plurality of light-emitting elements used as a level meter during the reception intensity display mode is further included, and the power lamp can be configured to have different light emission patterns in the state display mode and the reception intensity display mode. Accordingly, whether the current operation mode is the state display mode or the reception intensity display mode can be clearly displayed by the light emission pattern of the power lamp. Moreover, different light-emitting patterns may be that one LED is lighted and the other LED blinks, or that the blinking patterns are different although both LEDs blink. In addition, in a case of multi-color LEDs such as two-color LED, three-color LED or the like, light-emitting colors may be different.

### Effect

According to the present invention, the wireless communication device can be provided which is capable of issuing a notification concerning a radio wave reception intensity and the occurrence of various states such as an error state using an inexpensive display device such as LEDs while achieving a decrease in the number of components.

### BRIEF DESCRIPTION OF THE DRAWINGS

FIG. 1 is a schematic system configuration diagram of a remote monitoring system for hot-water supply system in which a relay adaptor serving as a wireless communication device of one embodiment of the present invention is used.

FIG. 2 is a diagram showing a display example when three LEDs of the relay adaptor are used as a level meter to display reception intensity.

### DESCRIPTION OF THE EMBODIMENTS

In the following, embodiments of the present invention are described based on the drawings.

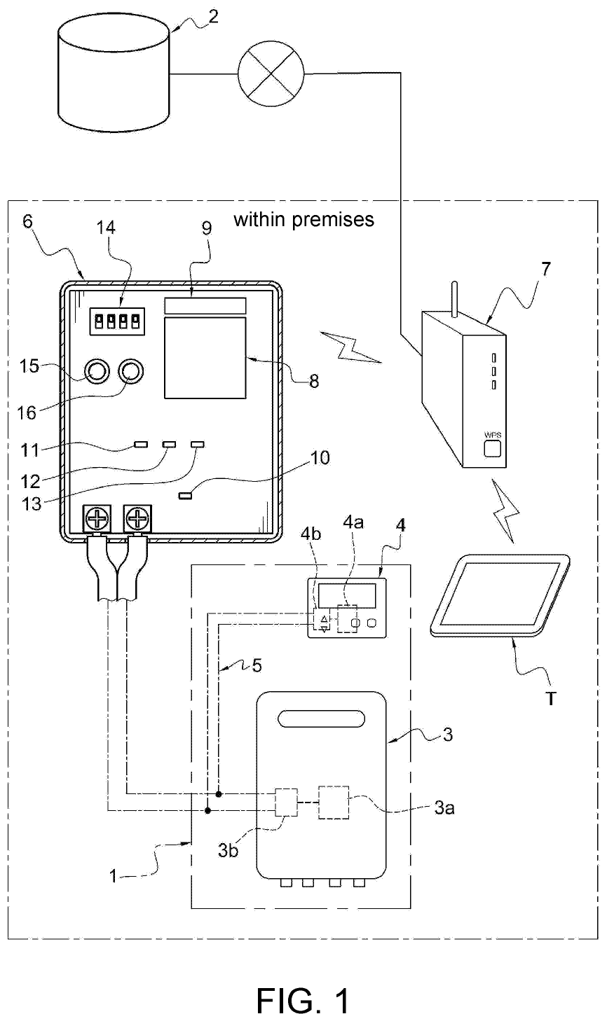

FIG. 1 shows an example of a system configuration of a remote monitoring system for monitoring operation status of a hot-water supply system 1 by a remote management server 2.

The hot-water supply system 1 includes a hot-water supply device 3 and a remote controller 4 for giving operation instructions of the hot-water supply device 3. The hot-water supply device 3 and the remote controller 4 are communicably connected via a two-core communication line 5. More specifically, a control microcomputer 3a (control part) and a two-core communication circuit 3b are built in the hot-water supply device 3, a control microcomputer 4a (control part) and a two-core communication circuit 4b are built in the remote controller 4, and the control microcomputers 3a and 4a are configured to be capable of serial communication via the two-core communication line 5 under a predetermined communication protocol. In addition, the hot-water supply device 3 can be configured to output a power supply voltage for external equipment to the two-core communication line 5; in this case, communication data can be superimposed upon the power supply voltage. The remote controller 5 may operate by the power supply voltage supplied from the hot-water supply device 3 via the two-core communication line 5, or may have a built-in current circuit independently.

The remote monitoring system includes the management server 2, a relay adaptor 6 (the wireless communication device of the present invention) which is communicably connected to the hot-water supply device 3 and/or the remote controller 4 via the two-core communication line 5, and a wireless LAN router 7 (another wireless communication device) which is communicably connected to the management server 2 via a wide area network such as internet. The relay adaptor 6 can be configured to operate by the power supply voltage supplied via the two-core communication line 5.

Moreover, the management server 2 may be maintained and managed by a remote monitoring service provider, and the relay adaptor 6 and the wireless LAN router 7 may be possessed or rented by a user and disposed within the premises of the user. In addition, although not shown in the diagram, the management server 2 is accessible via the internet or a private line from a monitoring terminal (not shown) disposed on a call center of the hot-water supply system 1 for error confirmation, service arrangement and the like.

The relay adaptor 6 includes a wireless communication controller 8 and an antenna 9 for performing wireless communication with the wireless LAN router 7 under a predetermined communication protocol (for example, IEEE802.11n/IEEE802.11g/IEEE802.11b and the like). The wireless communication controller 8 may be, for example, a commercial custom programmable Wi-Fi module, and in the embodiment, the wireless communication controller 8 is made to function as a main control part of the relay adaptor 6. Moreover, a microprocessor different from a wireless communication controller 61 can also be mounted as a main control part.

The control part 8 of the relay adaptor 6 has the following functions, namely, an information collect function, by which various information concerning the hot-water supply system 1 and stored in the control part of the hot-water supply device 3 or the remote controller 4 is collected by the communication with the hot-water supply system 1, an information transmission function by which the collected information is transmitted to the management server 2, a first communication failure detection function by which the occurrence of a communication failure with the hot-water supply system 1 is detected, a second communication failure detection function by which the occurrence of a communication failure with the wireless LAN router 7 is detected, a third communication failure detection function by which the occurrence of a communication failure between the wireless LAN router 7 and the management server 2 is detected, and a radio wave intensity detection function by which reception radio wave intensity received from the wireless LAN router 7 is detected.

These functions can be achieved by the functions that are installed in the wireless communication controller 8 in an initial state or by custom programming of the wireless communication controller 8. For example, the radio wave intensity detection function is achieved by an RSSI detection function that is installed in many of commercial wireless communication controllers 8. In addition, the timing to implement each function can be appropriately designed. For example, the information collect function and the information transmission function may be implemented regularly at predetermined intervals, or be implemented when an information transmission request from the management server 2 is received. In addition, the first communication failure detection function to the third communication failure detection function may detect the occurrence of the respective communication failures based on communication errors that are generated during the implementation of the information collect function and the information transmission function, or detect the occurrence of the respective communication failures based on results obtained by implementing test transmission and reception of appropriate dummy data at a predetermined timing independently from the processing of the information collect function and the information transmission function, the occurrence of the communication failure can be detected by other appropriate processing.

Furthermore, the relay adaptor 6 includes a LED 10 (light-emitting element) that functions as a power lamp, a first LED 11, a second LED 12 and a third LED 13 (light-emitting element) for displaying various states, a DIP switch 14 for various settings, an operation part 15 for performing switching operation of display operation modes of the three LEDs 11, 12, 13, and a WPS button 16 for performing the setting of connection to the wireless LAN router 7. Moreover, the operation part 15 and the WPS button 16 can be configured by push-button momentary switches and the like. In addition, the configuration can also be that when the operation part 15 is pressed for a long time, the operation is received by the control part 8 as a switching operation of the display operation mode, and when the operation part 15 is pushed momentarily, the operation is received by the control part 8 as an operation for implementing another function (for example, ON/OFF switch of the power). In addition, a detachable front cover (not shown) can be arranged on the relay adaptor 6, and the configuration may be that in a state that the front cover is mounted, the power lamp 10 is visible from outside but the first LED 11 to the third LED 13 are covered and hidden by the front cover so as not to be visible from outside. During a setting operation, a maintenance operation or the like of the relay adaptor 6, the first LED 11 to the third LED 13 can be confirmed by removing the front cover.

The light emission control of the LEDs 10-13 can be performed individually by the control part 8, and the control part 8 performs the display operation of the LEDs 10-13 in any display operation mode of the state display mode and the reception intensity display mode that are described later. In addition, the three LEDs 11, 12, 13 for displaying various states are arranged in a single row, and the LED 10 that functions as a power lamp is disposed apart from the three LEDs 11, 12, 13. Moreover, the light-emitting colors of the LEDs 10-13 can be set as mutually different colors.

The control part 8 is configured to be capable of switching the display operation mode of the three LEDs 11-13 to the state display mode and the reception intensity display mode, and the control part 8 is configured to perform a display operation in the state display mode immediately after starting and is switched to the reception intensity display mode after a period of a predetermined time (for example, 15 minutes) when the operation part 15 is pressed for a long time. In addition, it is configured so that after being switched to the reception intensity display mode, the display operation mode automatically switches to the state display mode when a predetermined time elapses.

In the state display mode, the control part 8 displays that the current mode is the state display mode by lighting the power lamp 10, and lights the first LED 11 when the establishment of the communication with the hot-water supply system 1 is detected by the first communication failure detection function, lights the second LED 12 when the establishment of the communication with the wireless LAN router 7 is detected by the second communication failure detection function, and lights the third LED 13 when the establishment of the communication between the wireless LAN router 7 and the management server 2 is detected by the third communication failure detection function. That is, when the communication in each section is normal, the first communication failure detection function to the third communication failure detection function lights the first LED 11 to third LED 13. On the other hand, the control part 8 in the state display mode is configured so that, when the occurrence of a first error state that the communication with the hot-water supply system 1 is disabled is detected by the first communication failure detection function, first notification processing is performed in which the occurrence of the first error state is notified by getting the first LED 11 to blink, when the occurrence of a second error state that the communication with the wireless LAN router 7 is disabled is detected by the second communication failure detection function, second notification processing is performed in which the occurrence of the second error state is notified by getting the second LED 12 to blink, and when the occurrence of a third error state that the communication between the wireless LAN router 7 and the management server 2 is disabled is detected by the third communication failure detection function, third notification processing is performed in which the occurrence of the third error state is notified by getting the third LED 13 to blink. Furthermore, when any error state of the first error state to the third error state occurs, by getting the power lamp 10 to blink in a predetermined blinking pattern, the user can be visually notified from outside that some communication failure occurs even when the front cover is mounted.

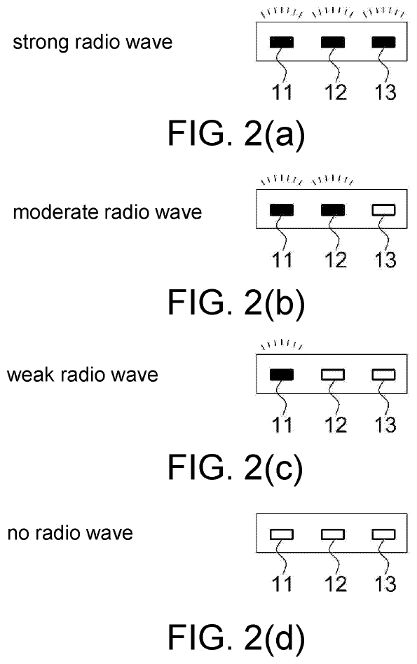

On the other hand, when it is switched to the reception intensity display mode, the control part 8 is configured to display that the current mode is the reception intensity display mode by getting the power lamp 10 to blink, and implement reception intensity display processing in which the magnitude of the reception intensity from the wireless LAN router 7 is displayed using the first to the third LED 11, 12, 13 as a four-step level meter as illustrated in FIG. 2. Preferably, during the reception intensity display mode, the reception intensity can be re-measured at predetermined intervals (for example, every few seconds) to update the level meter display by the three LEDs 11, 12, 13 at any time, and the level meter display can also be updated by a predetermined update request operation. Moreover, preferably, the blinking pattern of the power lamp 10 during the reception intensity display mode is set to a blinking pattern different from the blinking pattern of the power lamp 10 when any of the first error state to the third error state occurs in the state display mode.

When the relay adaptor 6 of the embodiment is disposed within the premises of the user, first, by connecting the two-core communication line 5 to the relay adaptor 6, a power supply voltage is supplied to the relay adaptor 6 via the two-core communication line 5 to start the control part 8 of the relay adaptor 6. Next, by setting the wireless LAN router 7 to a WPS connection holding state and operating the WPS button 16 of the relay adaptor 6, the wireless communication between the wireless LAN router 7 and the relay adaptor 6 is established. Moreover, when a tablet portable terminal T that displays various states, energy consumption or the like of the hot-water supply system 1 is connected with the wireless LAN router 7, the control part 8 of the relay adaptor 6 can also be configured so that a manual setting for connecting the relay adaptor 6 to the wireless LAN router 7 can be performed by the operation of the portable terminal T.

When the connection with the wireless LAN router 7 is established, the control part 8 of the relay adaptor 6 is set to the state display mode, and as mentioned above, whether the communication with the hot-water supply system 1, the wireless LAN router 7 and the management server 2 is established or whether the communication failure occurs is respectively displayed by the first to the third LED 11, 12, 13.

In addition, when constructers determine a fixed installation position of the relay adaptor 6, the relay adaptor 6 is switched to the reception intensity display mode by pressing the operation part 15 for a long time, and the reception intensity from the wireless LAN router 7 can be visually displayed in real time using the first to the third LED 11, 12, 13 as a level meter to search a site with the largest reception intensity.

The present invention is not limited to the aforementioned embodiment and can be appropriately changed in design. For example, in the aforementioned embodiment, the hot-water supply system is exemplified as including a single hot-water supply device 3, but the hot-water supply system may also be a multi-hot-water supply system in which a plurality of hot-water supply devices 3 are linked. In this case, a system controller that generally manages operations of the plurality of hot-water supply devices 3 can be arranged independently, and the information of the hot-water supply system can be obtained by the relay adaptor 6 by communicably connecting the system controller with the relay adaptor 6. In addition, the embodiment of the single-row arrangement of the light-emitting elements is exemplified as a horizontal arrangement, but the single-row arrangement may also be a vertical arrangement or an oblique arrangement.

In addition, in the aforementioned embodiment, there are three state display LEDs different from the power lamp, but there may also be two state display LEDs or four or more state display LEDs. In addition, the power lamp may not be arranged, and one of the state display LEDs arranged in a single row may function as the power lamp during the state display mode. In addition, a plurality of LEDs which is a part of the three or more state display LEDs arranged in a single row can also be configured to function as a level meter during the reception intensity display mode.

In addition, in the aforementioned embodiment, an example is shown in which a four-step level meter display from all lights on to all lights off is performed to display the reception intensity by three LEDs, but by combining a blinking state in addition to light on and light off, the reception intensity can be distinguished into five steps or more by three LEDs to perform the level meter display; for example, the level meter display having seven steps of the following (1)-(7) can be performed. Furthermore, by varying a blinking speed of the LED in blinking state according to the reception intensity, the reception intensity can also be substantially steplessly displayed.

| | | |
|---|---|---|
| (1) first LED: light on | second LED: light on | third LED: light on |
| (2) first LED: light on | second LED: light on | third LED: blinking |
| (3) first LED: light on | second LED: light on | third LED: light off |
| (4) first LED: light on | second LED: blinking | third LED: light off |
| (5) first LED: light on | second LED: light off | third LED: light off |
| (6) first LED: blinking | second LED: light off | third LED: light off |
| (7) first LED: light off | second LED: light off | third LED: light off |

### DESCRIPTION OF THE SYMBOLS

1 hot-water supply system
2 management server
6 wireless communication device (relay adaptor)
7 other wireless communication device (wireless LAN router)
8 control part
10 power lamp
11 first light-emitting element
12 second light-emitting element
13 third light-emitting element

What is claimed is:

1. A wireless communication device, which performs wireless communication with other wireless communication devices, and which comprises a control part, and a first light-emitting element and a second light-emitting element to which light emission control can be independently performed by the control part, wherein
the control part is configured to be capable of switching an operation mode to a state display mode or a reception intensity display mode,
during the state display mode, when a predetermined first state occurs, the control part implements first notification processing in which the occurrence of the first state is notified using the first light-emitting element, and when a predetermined second state occurs, the control part implements second notification processing in which the occurrence of the second state is notified using the second light-emitting element, and
during the reception intensity display mode, the control part implements reception intensity display processing in which the magnitude of reception intensity from other wireless communication devices is displayed using the first light-emitting element and the second light-emitting element as a level meter.

2. The wireless communication device according to claim 1, further comprising:
a third light-emitting element to which the light emission control can be performed independently by the control part, and the first light-emitting element to the third light-emitting element are arranged in a single row,
during the state display mode, when a predetermined third state occurs, the control part implements third notification processing in which the occurrence of the third state is notified using the third light-emitting element, and
during the reception intensity display mode, the control part implements the reception intensity display processing in which the magnitude of the reception intensity from other wireless communication devices is displayed using the first light-emitting element to the third light-emitting element as a level meter.

3. The wireless communication device according to claim 1, further comprising:
an operation part for switching the operation mode of the control part from the state display mode to the reception intensity display mode, and the control part is configured to be automatically switched to the state display mode when a predetermined time elapses after the control part is switched to the reception intensity display mode by the operation of the operation part.

4. The wireless communication device according to claim 1, further comprising:
a power lamp disposed apart from the plurality of light-emitting elements used as a level meter during the reception intensity display mode, and the power lamp has different light emission patterns in the state display mode and the reception intensity display mode.
